(19) United States
(12) Patent Application Publication
(10) Pub. No.: US 2010/0206989 A1
(43) Pub. Date: Aug. 19, 2010

(54) CORROSION-RESISTANT CONNECTION BETWEEN A FIRST COMPONENT AND SECOND COMPONENT

(75) Inventors: Thorsten Roming, Himmelpforten (DE); Hauke Kirstein, Ellerau (DE); Thorsten Schroeer, Buxtehude (DE)

Correspondence Address: OCCHIUTI ROHLICEK & TSAO, LLP, 10 FAWCETT STREET, CAMBRIDGE, MA, 02138, US

(73) Assignee: Airbus Operations GmbH, Hamburg (DE)

(21) Appl. No.: 12/665,826

(22) PCT Filed: Jun. 25, 2008
(86) PCT No.: PCT/EP2008/058097

§ 371 Date: May 5, 2010

Related U.S. Application Data
(60) Provisional application No. 60/946,202, filed on Jun. 26, 2007.

(30) Foreign Application Priority Data
Jun. 26, 2007 (DE) 10 2007 029 337.4

(51) Int. Cl. B64C 1/12; B32B 15/04; B32B 18/00; B32B 5/00

(52) U.S. Cl. 244/132; 428/450; 428/469; 428/472.2; 428/334

(57) ABSTRACT

The invention relates to a connection 1 between a first component and a second component, the first component being formed from an aluminium alloy in particular and the second component being formed from a carbon-fibre-reinforced plastics material in particular. The first component is a rib 6 in particular and the second component is preferably an angle bracket 7, with which the rib 6 is connected to an aircraft fuselage skin 2 within a fuselage reinforcement structure. The connection 1 between the components comprises, according to the invention, a ceramic coating 16 which is applied for protection against corrosion at least in the region of a contact area 9 between the components, the components being riveted and/or adhesively bonded. The ceramic coating 16 is less than 0.1 mm thick and may be formed from a mixture of aluminium oxide (Al₂O₃) and TiO₂ for example.

The invention relates to a connection, for use in aircraft in particular, between a first component and a second component, the first component being formed from a metallic material, in particular an aluminium alloy, and the second component being formed from a composite material, in particular a carbon-fibre-reinforced plastics material.

Components made of carbon-fibre-reinforced plastics materials are increasingly used in the modern aircraft construction industry as connection arrangements for reinforcing the fuselage. Mechanically connecting carbon-fibre-reinforced components and conventional components, which are formed, for example, from aluminium alloy materials, to form a complex connection arrangement is problematic for numerous reasons.

On the one hand, the coefficients of thermal expansion of the aforementioned materials are different, which may lead to temperature-induced stresses in the connection. On the other hand, a mechanical connection between metal components and composite fibre components, in particular in the region of the component contact area, is susceptible to corrosion processes to a very high degree.

The object of the invention is to provide a substantially corrosion-resistant connection between a first component formed from an aluminium alloy material and a second component formed from a composite material.

This object is achieved by a connection with the features of claim 1.

Corrosion processes between the first component and the second component are substantially prevented by providing the first component and/or the second component with a ceramic coating as a protection against corrosion, at least in the region of a contact area.

The ceramic coating is preferably applied to the first component, formed from an aluminium alloy in particular, at least in the region of the contact area between the components. Alternatively, the second component, or the first and second components, can be provided with a ceramic coating. The second component is generally formed from a carbon-fibre-reinforced thermoplastic or thermosetting polymer. The second component is particularly preferably formed from a carbon-fibre-reinforced, heavy-duty thermoplastic polymer or a carbon-fibre-reinforced epoxy resin material.

The ceramic coating is applied to the first and/or the second component by the manufacturer while applying suitable pressure and temperature parameters. The layer thickness of the ceramic coating is preferably less than 0.1 mm.

Further advantageous embodiments of the connection are explained in the other claims.

In the drawings:

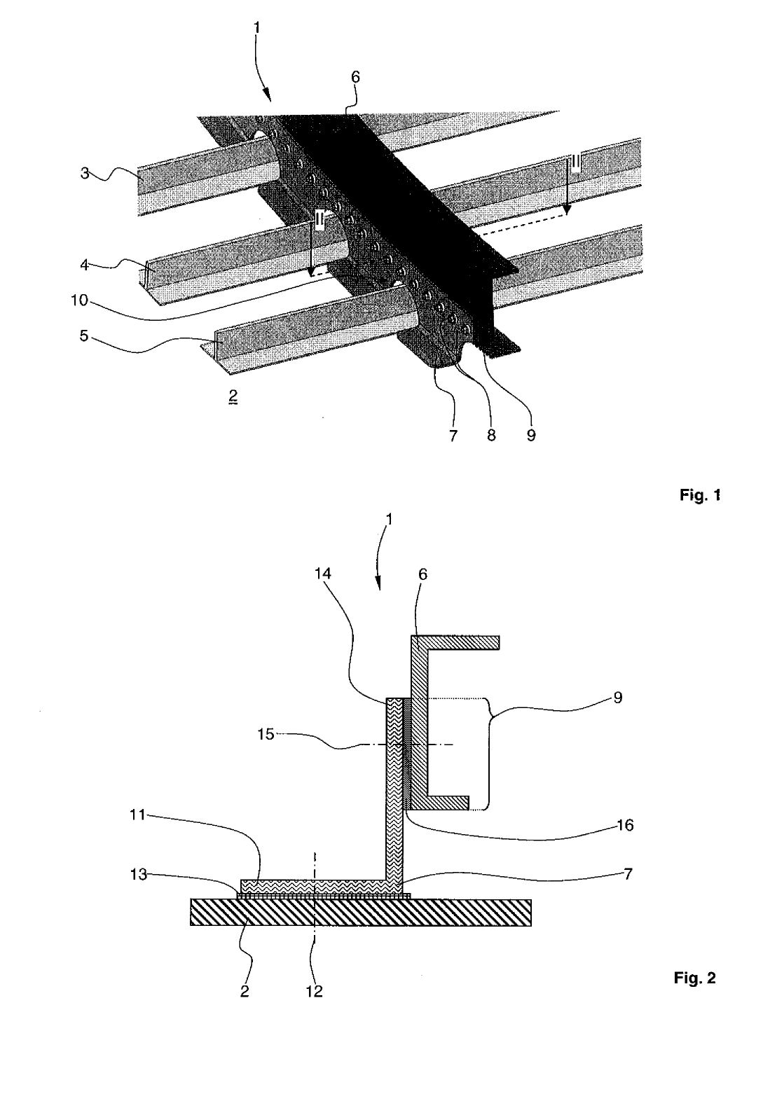

FIG. 1 is a perspective view of a detail of an aircraft fuselage comprising a connection according to the invention, and

FIG. 2 is a sectional view along the line II-II in FIG. 1.

In the drawing, like constructional elements bear like reference numerals.

FIG. 1 is a perspective view of a detail of an aircraft fuselage using a connection 1 formed according to the invention.

Fixed to a fuselage skin 2 of a fuselage are a plurality of reinforcement profiles (known as “stringers”), of which only reinforcement profiles 3 to 5 are shown for the sake of the clarity of the drawing. The reinforcement profiles 3 to 5, which each have a T-shaped cross-section, extend parallel to a longitudinal axis of the fuselage (not shown) at a substantially uniform distance from one another. A large number of ribs, only one rib 6 of which is marked in the representation in FIG. 1, extend transversely to the reinforcement profiles 3 to 5. The rib 6 is preferably an annular rib formed from a high-strength aluminium alloy material.

The rib 6 (first component) is mechanically connected to the fuselage skin 2 by a curved angle bracket 7 (second component) which is formed from a carbon-fibre-reinforced plastics material, in particular a high-strength thermoplastic polymer, in which a large number of carbon fibres are embedded to form a fibre-reinforced arrangement. The bend radius of the angle bracket 7, which preferably has an L-shaped cross-section, is matched as closely as possible to the radius of curvature of the fuselage. Alternatively, the angle bracket 7 may also be formed from a carbon-fibre-reinforced thermosetting polymer, such as a curable epoxy resin with carbon fibres embedded therein.

The angle bracket 7 is connected to the rib 6 by a large number of rivets 8. The rib 6 is provided with a preferably thin layer of a ceramic coating (not shown in FIG. 1), at least in the region of a contact area 9 with the angle bracket 7, in order to prevent corrosion processes between the components in the region of the contact area 9. The ceramic coating is preferably less than 0.1 mm thick. A further sealing layer (not shown in greater detail) may also be arranged in the region of the contact area 9. The rib 6 which is connected to the angle bracket 7 in the region of the contact area 9 represents the connection 1 according to the invention, a large number of the connections shown in FIGS. 1 and 2 being required to produce the fuselage reinforcement structure. The reinforcement profiles 3 to 5 are guided underneath the rib 6 or “through” the angle bracket 7 through approximately semicircular recesses of the angled profile 7, which are sunk into a vertical web and one recess 10 of which is provided with a reference numeral by way of example. In order that the reinforcement profiles 3 to 5 rest as completely as possible over their surface on the fuselage skin 2, a lower (base or foot) flange of the angled profile 7 is provided with rectangular recesses in the region of the reinforcement profiles 3 to 5, the width of the recesses approximately corresponding in each case to the width of the lower (base or foot) flanges of the reinforcement profiles 3 to 5.

The angle bracket 7 and the fuselage skin 2 can be connected by means of rivets, screws and/or adhesive, for example.

FIG. 2 is a cross-section through a connection formed according to the invention.

A first leg 11 (lower or base flange) of the angle bracket 7 is connected to the fuselage skin 2 by means of a rivet connection 12. A sealing layer 13 is arranged between the angle bracket 7 and the fuselage skin 2. The sealing layer 13 ensures that the fuselage is pressure-tight. The sealing layer 13 does not act to protect against corrosion. A second leg 14 (vertical web) of the angle bracket 7 is connected to the rib 6 by a further rivet connection 15.

The rib 6 is provided with a ceramic coating 16, at least in the region of the contact area 9. The ceramic coating 16 is up to 0.1 mm thick and is formed, for example, from a ceramic material made of Al₂O₃ (aluminium oxide) and TiO₂. The ceramic coating 16 may alternatively be formed from other ceramic materials and/or chemical compounds, as long as they are sufficiently electrically insulating to prevent electrolytic corrosion processes (contact corrosion) occurring between the angle bracket 7 and the rib 6, which is formed in this embodiment from an aluminium alloy.

The ceramic coating 16 can be sprayed onto the contact area 9 using the “HVOF” process (high-velocity oxy-fuel method). In order to form the ceramic coating 16, the ceramic particles are sprayed in this process by means of converging or diverging (Laval) nozzles, using kerosene for example, at a temperature of up to 3,500° C. The ceramic particles are accelerated to 2,000 to 2,500 m/s by a flame arc and are sprayed at this high velocity against the contact area 9. The ceramic particles cool very rapidly, however, thus avoiding the working region becoming excessively heated. The ceramic particles are attached very strongly to the component surface in this forging-like process due to the fact that said ceramic particles impact the contact area 9 at an extremely high velocity. As a result, the ceramic coating is very hard and resistant to wear. The ceramic coating 16 does not flake off from the contact area 9 when said area is deformed, regardless of the high degree of hardness of said ceramic coating.

The ceramic coating 16 can be applied both to aluminium alloy components and to carbon-fibre-reinforced plastics material components.

Alternatively, it is possible to provide the second component, which is formed from the non-metal material (generally a carbon-fibre-reinforced composite material), with a ceramic coating at least in portions in the region of the contact area 9 between the two components. The second component may be coated with a ceramic material in the region of the contact area as an alternative to or in addition to the first component, which is generally formed from a metal material (generally a high-strength aluminium alloy) being coated therewith.

The stationary or fixed connection 1 comprising a ceramic coating 16, which is arranged at least in the region of the contact area 9 between the two components, is suitable for corrosion-resistant fastening and connecting applications between any types of components in aircraft, beyond the embodiment explained by way of example in the descriptions of FIGS. 1 and 2 located in the region of the fuselage structure of an aircraft.

### LIST OF REFERENCE NUMERALS

1 connection arrangement
2 fuselage skin
3 reinforcement profile (stringer)
4 reinforcement profile (stringer)
5 reinforcement profile (stringer)
6 rib
7 angle bracket
8 rivet
9 contact area
10 recess (angle bracket)
11 first leg (angle bracket)
12 rivet connection
13 sealing layer
14 second leg (angle bracket)
15 rivet connection
16 ceramic coating

1. A connection for use in aircraft comprising a first component made of a metal material and a second component made of a composite fibre material, wherein the components are connected to one another, forming a contact area, and wherein the contact area is provided with a HVOF ceramic coating on the first and/or second component in order to protect the connection from corrosion.

2. The connection according to claim 1, wherein the first component is formed from an aluminium alloy.

3. The connection according to claim 1, wherein the second component is formed from a carbon-fibre-reinforced plastics material.

4. The connection according to claim 1, wherein the first component is a rib (6).

5. The connection according to claim 1, wherein the second component is an angle bracket for producing a mechanical connection between the rib and a fuselage skin of the aircraft.

6. The connection according to claim 1, wherein the ceramic coating is formed from Al₂O₃, TiO₂ or another ceramic material.

7. The connection according to claim 1, wherein the layer of the ceramic coating is less than 0.1 mm thick.

8. The connection according to claim 1, wherein the angle bracket is formed from a carbon-fibre-reinforced thermoplastic polymer.
